(19) United States
(12) Patent Application Publication
(10) Pub. No.: US 2026/0009642 A1
(43) Pub. Date: Jan. 8, 2026

(54) APPARATUS AND METHOD FOR PREDICTING SEA LEVEL FLUCTUATIONS

(71) Applicant: KOREA INSTITUTE OF OCEAN SCIENCE & TECHNOLOGY, Busan (KR)

(72) Inventors: Moonjin LEE, Daejeon (KR); Tae Sung KIM, Daejeon (KR); Yong Myung KIM, Daejeon (KR)

(73) Assignee: KOREA INSTITUTE OF OCEAN SCIENCE & TECHNOLOGY, Busan (KR)

(21) Appl. No.: 19/258,283

(22) Filed: Jul. 2, 2025

(30) Foreign Application Priority Data
Jul. 3, 2024 (KR) 10-2024-0087585

(51) Int. Cl. G01C 13/00

(52) U.S. Cl. CPC G01C 13/008

(57) ABSTRACT

An apparatus and method for predicting sea level fluctuations are disclosed. The method for predicting sea level fluctuations includes: acquiring past time-series data of past wind stress and past sea level height, determining an optimal length of a time lag of a response function representing a convolution relationship between the past wind stress and the past sea level height and a future sea level height, determining weighting factors of the past wind stress and the past sea level height in the response function to which the determined optimal length of the time lag is applied, and calculating the future sea level height using the response function to which the determined weighting factors are applied.

### CROSS REFERENCE TO RELATED APPLICATION

The present application claims priority to Korean Patent Application No. 10-2024-0087585 filed on Jul. 3, 2024, the entire contents of which are incorporated herein for all purposes by this reference.

### BACKGROUND

### Technical Field

The present invention relates to an apparatus and method for predicting sea level fluctuations.

### Description of Related Technology

A typhoon refers to a tropical cyclone accompanied by a storm, with a maximum wind speed at the center of 17 m/s or more, and is one of the most dangerous natural disasters.

In addition, during severe weather conditions such as a typhoon, the sea surface rises beyond the level of tidal height that can be relatively accurately predicted by astronomical tide calculations, and the elevated sea level overflows onto the land, which is referred to as a storm surge.

Such storm surges cause significant loss of life and property every year, and they occur within several hours of the onset of strong winds as a result of sea level rise caused by the strong wind. Therefore, rapid forecasting and response are essential.

### PRIOR ART LITERATURE

### Patent Document

Korean Patent Application Registration No. 10-1172317 (Aug. 2, 2012)

### SUMMARY

The present invention is directed to providing an apparatus and method for predicting sea level fluctuations, which calculates future sea level height using a response function to past sea level rise and wind-induced sea surface stress.

According to one aspect of the present invention, a method for predicting sea level fluctuations performed by an apparatus for predicting sea level fluctuations is disclosed.

A method for predicting sea level fluctuations according to an embodiment of the present invention includes: a step of acquiring past time-series data on past wind stress and past sea level height, a step of determining an optimal length of a response time lag of a response function that represents a convolution relationship between the past wind stress and the past sea level height and a future sea level height, a step of determining weighting factors of the past wind stress and the past sea level height in the response function to which the determined optimal response time lag is applied, and a step of calculating a future sea level height using the response function to which the determined weighting factors are applied.

According to another aspect of the present invention, an apparatus for predicting sea level fluctuations is disclosed.

An apparatus for predicting sea level fluctuations according to an embodiment of the present invention includes a memory that stores instructions and a processor that executes the instructions, wherein the instructions cause the processor to perform a method for predicting sea level fluctuations, the method comprising: acquiring past time-series data on past wind stress and past sea level height, determining an optimal length of a response time lag of a response function that represents a convolution relationship between the past wind stress and the past sea level height and a future sea level height, determining weighting factors of the past wind stress and the past sea level height in the response function to which the determined optimal response time lag is applied, and calculating a future sea level height using the response function to which the determined weighting factors are applied.

The apparatus and method for predicting sea level fluctuations according to an embodiment of the present invention enable rapid prediction of future sea level rise and forecasting of storm surges caused by sea level rise during storm events, by calculating future sea level height using a response function to past sea level rise and wind-induced sea surface stress.

### BRIEF DESCRIPTION OF THE DRAWINGS

FIG. 1 is a flowchart schematically illustrating a method for predicting sea level fluctuations performed by an apparatus for predicting sea level fluctuations according to an embodiment of the present invention.

FIG. 2 is a diagram schematically illustrating the configuration of an apparatus for predicting sea level fluctuations according to an embodiment of the present invention.

### DETAILED DESCRIPTION

Unless clearly indicated otherwise by the context, singular expressions used in this specification include plural expressions. In this specification, terms such as “comprise” or “include” should not be interpreted as necessarily including all the components or all the steps described in the specification, and some components or some steps may be omitted, or additional components or steps may be included. Also, terms such as “ . . . unit” or “module” described in the specification refer to a unit that processes at least one function or operation, and this may be implemented in hardware, software, or a combination of hardware and software.

Hereinafter, various embodiments of the present invention will be described in detail with reference to the accompanying drawings.

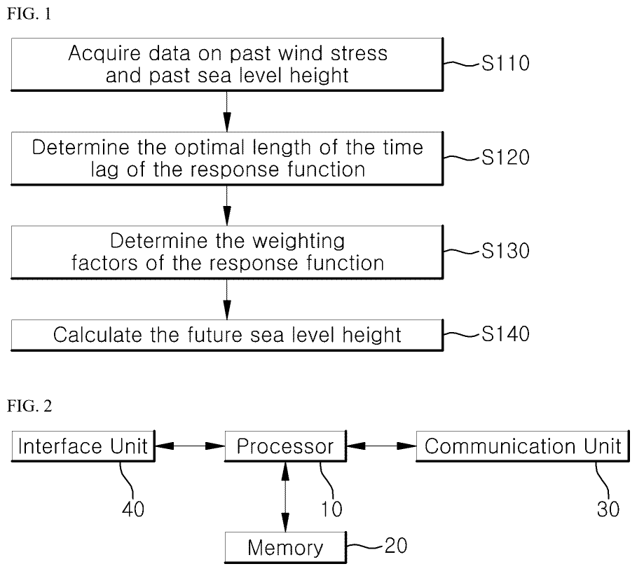

FIG. 1 is a flowchart schematically illustrating a method for predicting sea level fluctuations performed by an apparatus for predicting sea level fluctuations according to an embodiment of the present invention.

In step S110, the apparatus for predicting sea level fluctuations acquires past time-series data on past wind stress and past sea level height.

Here, the wind stress may be calculated by the following equation:

$$τ = {C}_{d} {ρ}_{a} W \qquad [ Equation 1 ]$$

Here, τ is the wind stress, C_{d} is the drag coefficient, ρₐ is the air density, and W is the wind speed.

For example, data on past wind stress may include past drag coefficients, air densities, and wind speeds for a specific sea area, which can be used to calculate the past wind stress.

In step S120, the apparatus for predicting sea level fluctuations determines the optimal length of the response time lag of the response function representing the convolution relationship between past wind stress and past sea level height and future sea level height.

Here, the response function (convolution kernel) can be expressed by the following equation:

$${ζ}_{t} = {\sum }_{i = 1}^{m} {a}_{i} {τ}_{t - i} + {\sum }_{j = 1}^{n} {b}_{j} {ζ}_{t - j} \qquad [ Equation 2 ]$$

Here, ζₜ is the future sea level height, tri is the past wind stress, and τₜ₋ᵢ is the past sea level height.

i is the time lag between the past wind stress and the future sea level height, and j is the time lag between the past sea level height and the future sea level height.

m is the optimal length of the time lag between the past wind stress and the future sea level height, and n is the optimal length of the time lag between the past sea level height and the future sea level height.

ai is the weighting factor for the past wind stress, and bj is the weighting factor for the past sea level height.

First, the optimal length (m) of the time lag between past wind stress and future sea level height can be determined by analyzing the cross-correlation between the past wind stress and the past time-series data of sea level height.

Next, the optimal length (n) of the time lag between past sea level height and future sea level height can be determined by analyzing the autocorrelation of the past time-series data of sea level height.

In other words, the optimal lengths of the time lags (m, n) can be determined based on the past time points of the time-series data that exhibit the highest correlation.

In step S130, the apparatus for predicting sea level fluctuations determines the weighting factors of past wind stress and past sea level height in the response function to which the optimal lengths of the determined time lags are applied.

Specifically, the apparatus applies the past time-series data of past wind stress and past sea level height to the response function with the optimal length (m) of the time lag between past wind stress and future sea level height, and the optimal length (n) of the time lag between past sea level height and future sea level height, and then determines the weighting factors ai for past wind stress and bj for past sea level height using the least squares method.

In step S140, the apparatus for predicting sea level fluctuations calculates the future sea level height using the response function with the determined weighting factors applied.

Specifically, when a storm occurs, the apparatus applies the current time-series data of current wind stress and current sea level height to the response function with the optimal time lag lengths and weighting factors already determined, thereby calculating the future sea level height.

Furthermore, if the calculated future sea level height exceeds a predetermined storm surge threshold, the apparatus can predict the occurrence of a storm surge caused by the sea level rise and issue a storm surge forecast.

FIG. 2 is a diagram schematically illustrating the configuration of the apparatus for predicting sea level fluctuations according to an embodiment of the present invention.

Referring to FIG. 2, the apparatus for predicting sea level fluctuations according to an embodiment of the present invention includes a processor 10, a memory 20, a communication unit 30, and an interface unit 40.

The processor 10 may be a CPU or a semiconductor device that executes processing instructions stored in the memory 20.

The memory 20 may include various types of volatile or non-volatile storage media. For example, the memory 20 may include ROM, RAM, and the like.

For instance, the memory 20 may store instructions for performing the method for predicting sea level fluctuations according to an embodiment of the present invention.

The communication unit 30 is a means for transmitting and receiving data with other devices via a communication network.

The interface unit 40 may include a network interface for connecting to a network and a user interface.

Meanwhile, the components of the above-described embodiments can be easily understood from a procedural perspective. In other words, each component may be regarded as an individual process. Also, the processes of the above-described embodiments can be easily understood from the viewpoint of the device components.

Furthermore, the technical contents described above can be implemented in the form of program instructions executable by various computer means and recorded on a computer-readable medium. The computer-readable medium may include program instructions, data files, data structures, or any combination thereof.

The program instructions recorded on the medium may be specially designed and configured for the embodiments or may be known and usable by those skilled in the art in computer software. Examples of computer-readable recording media include magnetic media such as hard disks, floppy disks, and magnetic tapes; optical media such as CD-ROMs and DVDs; magneto-optical media such as floptical disks; and hardware devices specially configured to store and execute program instructions, such as ROM, RAM, and flash memory.

Examples of program instructions include not only machine language code generated by compilers but also high-level language code that can be executed by a computer using interpreters or the like. The hardware device may be configured to operate as one or more software modules to perform the operations of the embodiments, and vice versa.

The embodiments of the present invention disclosed above are for illustrative purposes, and those skilled in the art having ordinary knowledge of the invention will appreciate that various modifications, changes, and additions may be made within the spirit and scope of the present invention. Such modifications, changes, and additions should be regarded as falling within the scope of the following claims.

### DESCRIPTION OF REFERENCE NUMERALS

10: Processor
20: Memory
30: Communication Unit
40: Interface Unit

What is claimed is:

1. A method for predicting sea level fluctuations performed by an apparatus for predicting sea level fluctuations, the method comprising:
acquiring past time-series data of past wind stress and past sea level height;
determining an optimal length of a time lag of a response function representing a convolution relationship between the past wind stress and the past sea level height and a future sea level height;
determining weighting factors of the past wind stress and the past sea level height in the response function to which the determined optimal length of the time lag is applied; and
calculating the future sea level height using the response function to which the determined weighting factors are applied.

2. The method for predicting sea level fluctuations according to claim 1, wherein the past wind stress is calculated using the following equation,
$$τ = {C}_{d} {ρ}_{a} W$$
here, τ is the wind stress, C_{d} is the drag coefficient, ρₐ is the air density, and W is the wind speed.

3. The method for predicting sea level fluctuations according to claim 1, wherein the response function is represented by the following equation,
$${ζ}_{t} = {\sum }_{i = 1}^{m} {a}_{i} {τ}_{t - i} + {\sum }_{j = 1}^{n} {b}_{j} {ζ}_{t - j}$$
here ζₜ is the future sea level height, τₜ₋ᵢ is the past wind stress, and ζₜ₋ⱼ is the past sea level height,
i is the time lag between the past wind stress and the future sea level height, and j is the time lag between the past sea level height and the future sea level height,
m is the optimal length of the time lag between the past wind stress and the future sea level height, and n is the optimal length of the time lag between the past sea level height and the future sea level height, and
ai is the weighting factor for the past wind stress, and bj is the weighting factor for the past sea level height.

4. The method for predicting sea level fluctuations according to claim 3, wherein the step of determining the optimal length comprises analyzing a cross-correlation between the past wind stress and the past time-series data of sea level height to determine the optimal length (m) of the time lag between the past wind stress and the future sea level height.

5. The method for predicting sea level fluctuations according to claim 4, wherein the step of determining the optimal length comprises analyzing an autocorrelation of the past time-series data of sea level height to determine the optimal length (n) of the time lag between the past sea level height and the future sea level height.

6. The method for predicting sea level fluctuations according to claim 5, wherein the step of determining the weighting factors comprises applying the past time-series data of past wind stress and past sea level height to the response function with the determined optimal time lag lengths (m, n), and determining the weighting factors ai for the past wind stress and bj for the past sea level height by using the least squares method.

7. An apparatus for predicting sea level fluctuations, comprising:
a memory configured to store instructions; and
a processor configured to execute the instructions,
wherein the instructions cause the apparatus to perform a method comprising:
acquiring past time-series data of past wind stress and past sea level height;
determining an optimal length of a time lag of a response function representing a convolution relationship between the past wind stress and the past sea level height and a future sea level height;
determining weighting factors of the past wind stress and the past sea level height in the response function to which the determined optimal length of the time lag is applied; and
calculating the future sea level height using the response function to which the determined weighting factors are applied.
